(19) United States
(12) Patent Application Publication
(10) Pub. No.: US 2009/0143102 A1
(43) Pub. Date: Jun. 4, 2009

(54) COMMUNICATION DEVICE

(76) Inventors: Masaya UMEMURA, Yokosuka (JP); Takatoshi Kato, Yokohama (JP)

Correspondence Address: MCDERMOTT WILL & EMERY LLP, 600 13TH STREET, N.W., WASHINGTON, DC, 20005-3096, US

(21) Appl. No.: 12/274,622

(22) Filed: Nov. 20, 2008

(30) Foreign Application Priority Data
Nov. 20, 2007 (JP) 2007-300329

(51) Int. Cl. H04M 1/00; G06F 15/16; G06F 15/167

(52) U.S. Cl. 455/557; 709/227; 709/213

(57) ABSTRACT

The communication device includes: a communication control section which periodically causes a radio communication module to establish a connection to the server; a data reception and transmission instructing section which instructs the communication control section to obtain files and directory information stored in the server when the connection is established, and stores the files and the directory information in memories; and an emulation processing section which notifies, when the communication device is coupled to the computer, the computer that the communication device is a mass storage class device, submits the directory information stored in the memories to the computer, refers, when designation of a file contained in the directory information is accepted from the computer, to the directory information to read the file from the memories, and sends the file to the computer.

### INCORPORATION BY REFERENCE

This application claims priority based on a Japanese patent application, No. 2007-300329 filed on Nov. 20, 2007, the entire contents of which are incorporated herein by reference.

### BACKGROUND OF THE INVENTION

The present invention relates to a communication device which communicates with a server or the like, obtains a file stored in the server or the like, and sends the file to a computer.

In order to access a file server provided on an intranet from an outside location, it is typical to couple a cellular phone to a laptop or mobile computer, establish a dial-up connection by using a modem function of the cellular phone, and access the file server.

As a method which externally obtains large-volume information, which is difficult to obtain by using a cellular phone, Japanese Patent Laid-open Publication No. 2002-032286 discloses a method which couples a cellular phone to a computer as described above.

However, in the conventional technology, there is a problem that, in order to obtain files stored in the file server, a user needs to perform various operations, such as an operation to call the file server, thus imposing a great burden on the user. Further, there is another problem that it is necessary to perform several steps to open the directory and operate the files, thus requiring a long period of time.

### SUMMARY OF THE INVENTION

In view of the above-mentioned problems inherent to the conventional technology, the present invention provides a communication device capable of obtaining files in a short period of time by reducing the number of steps to be performed by the user.

In order to solve the above-mentioned problems, according to an aspect of the present invention, a communication device includes:

communication means which performs, when the communication means is coupled to a computer, data communications between the computer and an external unit;

communication control means which causes the communication means to establish a connection to a file server which is specified in advance as a communication destination, every time a predetermined condition is satisfied;

data reception and transmission instructing means which instructs, when the connection to the file server is established, the communication control means to cause the communication means to obtain at least one file and directory information related to the at least one file, which are stored in the file server, and stores the at least one file and the directory information in a storage area; and

pseudo storage device means which notifies, when the communication means is coupled to the computer, the computer that the communication means is a mass storage class device to cause the computer to recognize the communication device as the mass storage class device, submits the directory information stored in the storage area to the computer, refers, when designation of a file contained in the directory information is accepted from the computer, to the directory information to read the file from the storage area, in which the file is stored, and sends the file to the computer.

Here, in the communication device,

the data reception and transmission instructing means may cause the communication means to obtain a plurality of electronic tallies into which the file is divided (by a secret sharing scheme), and to obtain, as the directory information, information indicating locations, in the storage area, of the plurality of electronic tallies, and store the plurality of electronic tallies which constitute the file and the directory information in the storage area, and

the pseudo storage device means may include file decoding means which reads, when the designation of the file is accepted from the computer, a plurality of electronic tallies which constitute the file from the storage area, and decodes the file from the plurality of electronic tallies.

Further, in the communication device,

the data reception and transmission instructing means may cause the communication means to obtain a plurality of pieces of division directory information into which the directory information is divided, and store the plurality of pieces of division directory information in the storage area, and

the pseudo storage device means may include directory information decoding means which reads, when the directory information is submitted to the computer, the plurality of pieces of division directory information which constitute the directory information from the storage area, and decodes the directory information from the plurality of pieces of division directory information.

In the aspect of the present invention, the communication device accesses a storage such as the file server every time the predetermined condition is satisfied, and obtains the at least one file and the directory information from the storage. The computer coupled to the communication device treats the communication device as a mass storage class device. Therefore, when the user desires to obtain a file stored in the storage, the user does not need to perform various operations such as an operation to call the storage such as the file server, and the overhead to obtain the file can be reduced.

According to the teaching herein, a communication device capable of reducing burdens imposed on a user when a computer obtains a file from a server via a cellular phone is provided.

These and other benefits are described throughout the present specification. A further understanding of the nature and advantages of the invention may be realized by reference to the remaining portions of the specification and the attached drawings.

### BRIEF DESCRIPTION OF THE DRAWINGS

In the accompanying drawings:

FIG. 1 is a diagram illustrating a configuration of a storage server according to an embodiment of the present invention;

FIG. 2 is a flowchart illustrating synchronization processing of the storage server according to the embodiment of the present invention;

FIG. 3 is a flowchart illustrating connection processing of the storage server according to the embodiment of the present invention;

FIG. 4 is a flowchart illustrating file reading processing of the storage server according to the embodiment of the present invention;

FIG. 5 is a flowchart illustrating file saving processing of the storage server according to the embodiment of the present invention;

FIG. 6 is an explanatory diagram illustrating data structures in memories of a cellular phone according to the embodiment of the present invention;

FIG. 7 is an explanatory diagram illustrating data structures of pieces of directory information according to the embodiment of the present invention;

FIG. 8 is an explanatory diagram illustrating data structures in memories of a cellular phone and in a memory card, according to Modification 1 of the embodiment of the present invention; and

FIG. 9 is an explanatory diagram illustrating data structures in a storage device of a computer and in memories of a cellular phone according to Modification 2 of the embodiment of the present invention.

### DESCRIPTION OF THE EMBODIMENT

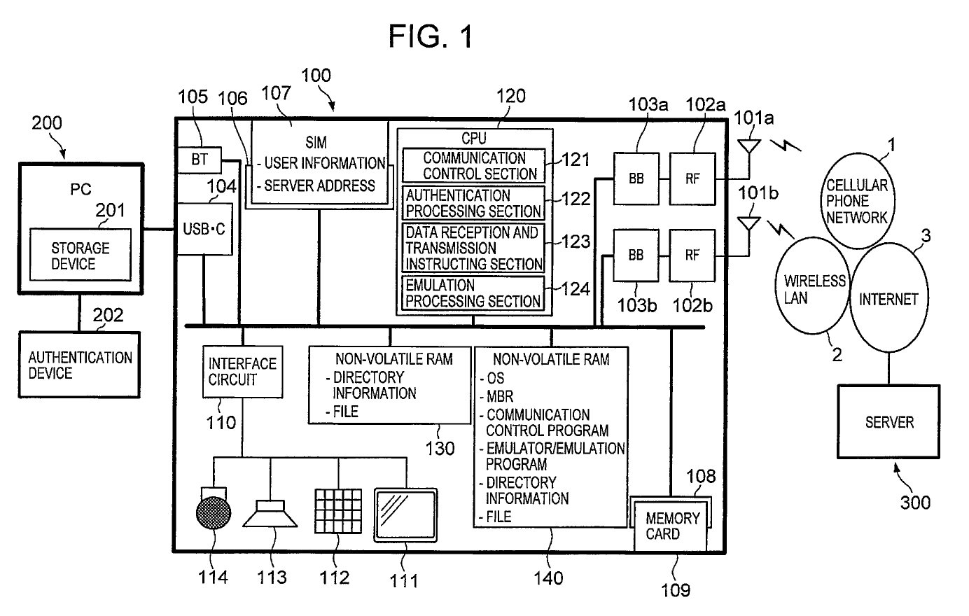

As illustrated in FIG. 1, a communication device according to this embodiment is a cellular phone 100 and can be coupled, via a cellular phone network 1 or a wireless LAN 2, to a server 300 coupled to the Internet 3 or to an intranet.

The cellular phone 100 includes a radio communication module used to establish a connection to the cellular phone network 1 and a radio communication module used to establish a connection to the wireless LAN 2. The radio communication modules include antennas 101a and 101b, radio frequency (RF) sections 102a and 102b which perform modulation processing, and base band (BB) sections 103a and 103b which perform base band processing.

Further, the cellular phone 100 includes a data communication interface connector 104, such as a universal serial bus (USB) connector, which couples the cellular phone 100 to a computer 200, a short-distance radio communication terminal 105 such as a Bluetooth (registered trademark) terminal, a subscriber identity module (SIM) card 107, a SIM slot 106 into which the SIM card 107 is inserted, a memory card 109, a memory card slot 108 into which the memory card 109 is inserted, a display device 111, a keyboard 112, a speaker 113, a microphone 114, an interface circuit 110 for the display device 111 and the like, a CPU 120 which executes various kinds of processing, a volatile RAM 130, and a non-volatile RAM 140 such as a flash memory.

The SIM card 107 stores information on the subscriber of the cellular phone 100, the communication address of the server 300, authentication information used to perform authentication processing between the cellular phone 100 and the server 300, and authentication information used to perform authentication processing between the cellular phone 100 and the computer 200. Note that the communication address of the server 300 and the pieces of authentication information may not be necessarily stored in the SIM card 107, but may be stored in the non-volatile RAM 140 or the like.

The volatile RAM 130 stores a file obtained from the server 300 and directory information related to the file. The non-volatile RAM 140 stores or installs in advance an OS, a master boot record (MBR), a communication control program, an emulator/emulation program, and the like. Further, the non-volatile RAM 140 stores a file obtained from the server 300 and directory information related to the file.

The CPU 120 includes, as functional sections, a communication control section 121 which performs communication control, an authentication processing section 122 which performs authentication processing between the cellular phone 100 and coupled equipment, a data reception and transmission instructing section 123 which causes the radio communication module to obtain a file and directory information from the server 300 under the control of the communication control section 121, an emulation processing section (pseudo storage device means) 124 which causes the computer 200 to recognize the cellular phone 100 as a storage device.

Among those functional sections, the communication control section 121 functions when the CPU 120 executes the communication control program or the like stored in the non-volatile RAM 140. Each of the authentication processing section 122, the data reception and transmission instructing section 123, and the emulation processing section 124 functions when the CPU 120 executes the emulator/emulation program or the like stored in the non-volatile RAM 140.

The computer 200 includes a storage device 201 such as an HDD, and further includes a human interface device used to input data and used for operations (not shown), a display device (not shown), a CPU (not shown), and a main memory and several storage devices (not shown). Further, an authentication device 202 which stores authentication information and a program for performing authentication processing between the computer 200 and the cellular phone 100 is coupled to the computer 200.

In this embodiment, the cellular phone 100, the computer 200, and the server 300, which have been described above, constitute a storage server.

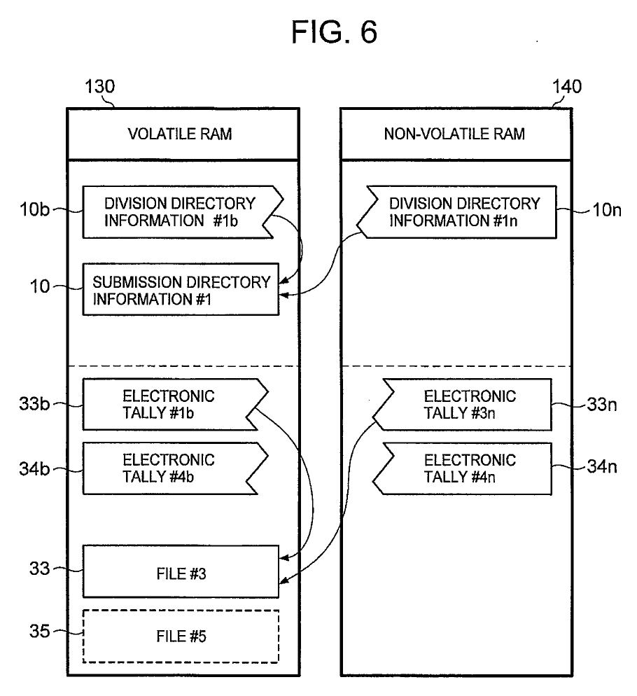

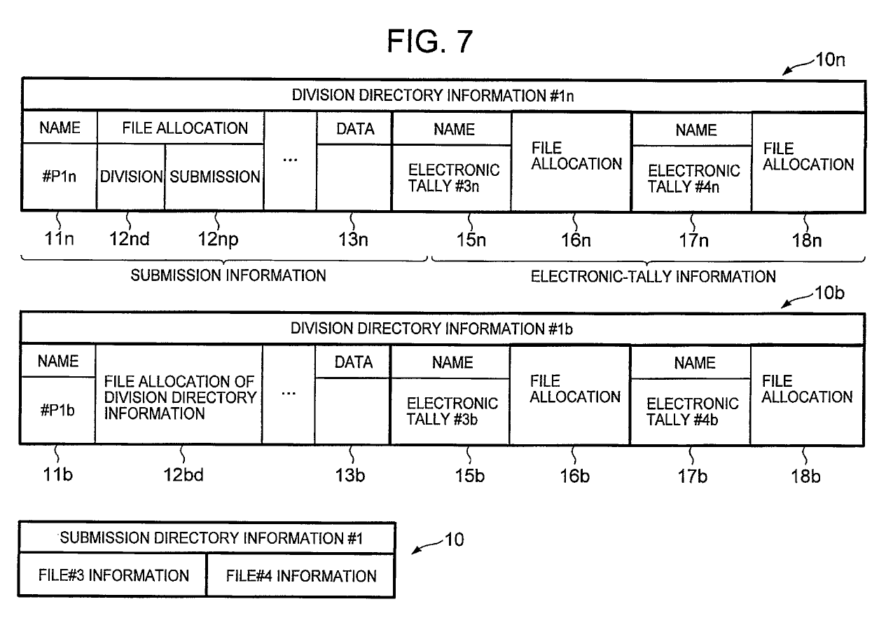

Next, data structures of directory information and files sent from the server 300 and the file allocation of the pieces of division directory information and the files are described with reference to FIGS. 6 and 7.

Directory information is divided into two pieces of division directory information (electronic tallies) 10b and 10n and the two pieces of division directory information 10b and 10n are sent from the server 300. As illustrated in FIG. 6, of the two pieces of division directory information 10b and 10n, the division directory information 10b is stored in the volatile RAM 130 and the division directory information 10n is stored in the non-volatile RAM 140.

Further, similarly, a file is divided into two electronic tallies 33b and 33n and the electronic tallies 33b and 33n are sent from the server 300. Of the electronic tallies 33b and 33n, the electronic tally 33b is stored in the volatile RAM 130 and the electronic tally 33n is stored in the non-volatile RAM 140. A file 33 is decoded from the electronic tallies 33b and 33n.

As illustrated in FIG. 7, each of the two pieces of division directory information 10b and 10n includes submission information used to submit the file allocation of a decoded file to the computer 200, and electronic-tally information indicating the file allocation of the electronic tallies constituting the file.

The submission information of the division directory information 10n stored in the non-volatile RAM 140 includes a file name “#P1n” 11n of the division directory information 10n itself, a file allocation 12nd of the division directory information 10n itself, a file allocation 12np of submission directory information 10 which is decoded from the two pieces of division directory information 10b and 10n, and decoding-source data 13n of the submission directory information 10. The electronic-tally information of the division directory information 10n includes a name “#3n” 15n of one of the electronic tallies which constitute a file#3 indicated by the submission directory information 10, a file allocation 16n of the electronic tally “#3n”, a name “#4n” 17n of one of the electronic tallies which constitute a file#4 indicated by the submission directory information 10, and a file allocation 18n of the electronic tally “#4n”.

The submission information of the division directory information 10b stored in the volatile RAM 130 includes a file name “#P1b” 11b of the division directory information 10b itself, a file allocation 12bd of the division directory information 10b itself, and decoding-source data 13b of the submission directory information 10. The electronic-tally information of the division directory information 10b includes a name “#3b” 15b of the other one of the electronic tallies which constitute the file#3 indicated by the submission directory information 10, a file allocation 16b of the electronic tally “#3b”, a name “#4b” 17b of the other one of the electronic tallies which constitute the file#4 indicated by the submission directory information 10, and a file allocation 18b of the electronic tally “#4b”.

The submission directory information 10, decoded from the pieces of submission information of the two pieces of division directory information 10b and 10n and visualized as actual directories and files, includes file#3 information and file#4 information (file attributes) in this embodiment. Each of the file#3 information and file#4 information includes of the file name, the file allocation, the file size, the name of a person permitted to read, write, modify, and delete the file, the date and time at which the file is generated or modified, the file names of the electronic tallies constituting the file, the file allocation (server 300) of the electronic tallies, a visible/invisible flag related to the file, and information on the valid duration and on the due date of deletion of the file. Those pieces of information are decoded from the pieces of decoding-source data 13n and 13b included in the submission information of the pieces of division directory information 10n and 10b.

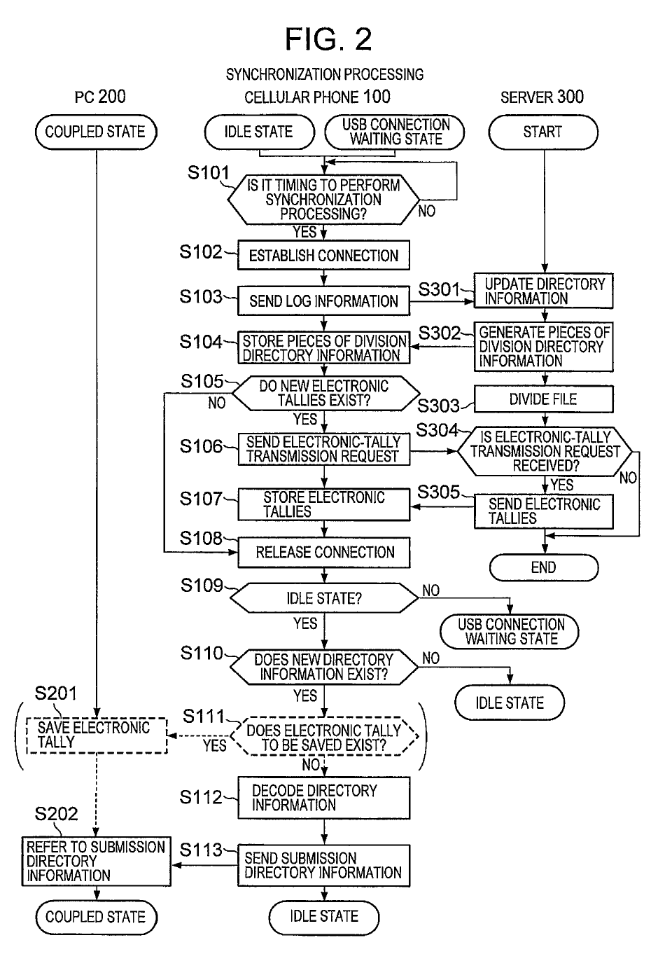

Next, operations of the storage server according to this embodiment are described with reference to flowcharts illustrated in FIGS. 2 to 5.

Synchronization Processing

With reference to the flowchart illustrated in FIG. 2, synchronization processing performed by the cellular phone 100 is described. Note that the cellular phone 100 performs the synchronization processing to hold all of various files visible to the computer 200 in the server 300 and directory information of the files.

First, when the cellular phone 100 is in an idle state or in a state of waiting for a USB connection, the data reception and transmission instructing section 123 judges whether or not it is timing to perform synchronization processing (S101). In the idle state, the cellular phone 100 and the computer 200 are both activated and coupled to each other. In the state of waiting for a USB connection, the cellular phone 100 is activated but is not coupled to the computer 200. It may be determined to perform the synchronization processing every 24 hours or every 12 hours, for example. Alternatively, the synchronization processing may also be performed when a predetermined button is pressed on the keyboard 112 of the cellular phone 100.

When judging that it is timing to perform synchronization processing, the data reception and transmission instructing section 123 causes the communication control section 121 to operate the antenna 101a, the RF section 102a, and the BB section 103a of the radio communication module to establish a connection to the server 300 by using the communication address of the server 300, stored in the SIM card 107 (S102). At this time, the communication control section 121 uses the communication address of the server 300, stored in the SIM card 107. Then, the data reception and transmission instructing section 123 refers to the files, the electronic tallies, the division directory information, and the submission directory information stored in the volatile RAM 130 and in the non-volatile RAM 140, generates log information indicating the use of each of the volatile RAM 130 and the non-volatile RAM 140, in other words, log information indicating the use of files by the computer 200, and notifies the server 300 of the log information (S103).

When the log information is received, the server 300 updates the directory information of files held in the server 300 (S301). For example, when the cellular phone 100 receives a new file from the computer 200 and the addition of the file is indicated by the log information, the server 300 adds the information on the file to the directory information. Further, when a certain file is used in the computer 200 and thus the number of times the file is used exceeds a specified value, the server 300 makes the file invisible. By updating the directory information, the server 300 can change the status of the file which has been visible in the directory information before the update to invisible after the update.

Next, the server 300 generates, from the updated directory information, pieces of division directory information 10b and 10n to be sent to the cellular phone 100 and sends the pieces of division directory information 10b and 10n to the cellular phone 100 (S302). When the number of visible files is increased because a new file is added, the server 300 divides the file into electronic tallies (S303). The server 300 waits for an electronic-tally transmission request to be sent from the cellular phone 100. When the electronic-tally transmission request is received (S304), the server 300 sends the electronic tallies constituting the file to the cellular phone 100 (S305) and ends its processing. On the other hand, when the electronic-tally transmission request cannot be received from the cellular phone 100 even if a predetermined period of time elapses, the server 300 ends its processing immediately.

When the pieces of division directory information 10b and 10n are sent from the server 300 (S302), the data reception and transmission instructing section 123 of the cellular phone 100 stores the pieces of division directory information 10b and 10n in the volatile RAM 130 and in the non-volatile RAM 140, respectively (S104). The data reception and transmission instructing section 123 stores the pieces of division directory information 10b and 10n at the locations indicated by the file allocation 12bd and 12nd (FIG. 7), respectively, of the pieces of division directory information 10b and 10n, sent from the server 300. In this embodiment, of the two pieces of division directory information 10b and 10n (FIGS. 6 and 7), the data reception and transmission instructing section 123 always stores the division directory information 10b in the volatile RAM 130 and stores the division directory information 10n in the non-volatile RAM 140.

Then, the data reception and transmission instructing section 123 judges whether or not new electronic tallies exist, depending on whether or not electronic-tally information (FIG. 7) is included in the two pieces of division directory information 10b and 10n (S105). When the electronic-tally information is included, the data reception and transmission instructing section 123 judges that new electronic tallies exist, and sends an electronic-tally transmission request to the server 300 (S16). In response to the electronic-tally transmission request, the server 300 sends the new electronic tallies to the cellular phone 100 in Steps S304 and S305 as described above. When the new electronic tallies are received, the data reception and transmission instructing section 123 stores the new electronic tallies at the locations indicated by the file allocation included in the electronic-tally information (FIG. 7) of the pieces of division directory information 10b and 10n (S107). In this embodiment, for the two pairs of electronic tallies 33b and 33n, and 34b and 34n, the data reception and transmission instructing section 123 always stores the electronic tallies 33b and 34b in the volatile RAM 130 and stores the electronic tallies 33n and 34n in the non-volatile RAM 140 (FIG. 6), in the same manner as for the above-mentioned two pieces of division directory information 10b and 10n.

When the new electronic tallies are stored in Step S107 or when it is judged in Step S105 that new electronic tallies do not exist, the data reception and transmission instructing section 123 causes the communication control section 121 to release the connection to the server 300 (S108).

Next, the emulation processing section 124 of the cellular phone 100 judges whether or not the cellular phone 100 is in the idle state (S109). When the cellular phone 100 is not in the idle state, in other words, when the cellular phone 100 is in the state of waiting for a USB connection, the state of waiting for a USB connection is maintained. On the other hand, when the cellular phone 100 is in the idle state, the emulation processing section 124 judges whether or not new directory information exists, in other words, whether or not pieces of division directory information have been received in Step S104 (S110). When pieces of division directory information have been received in Step S104, the emulation processing section 124 decodes the submission directory information 10 from the division directory information 10n stored in the non-volatile RAM 140 and the division directory information 10b stored in the volatile RAM 130 (FIGS. 6 and 7) (S112).

As described above with reference to FIG. 7, the submission directory information 10 indicates the names of files that can be submitted to the computer 200 and the file allocation of the files, but it is preferable that the submission directory information 10 does not include the file allocation of the electronic tallies constituting the files which do not need to be recognized by the computer 200. Further, when a file is made invisible because the number of times the file is used exceeds a specified value as described above, the submission directory information 10 does not include information on this invisible file.

Next, the emulation processing section 124 sends the decoded submission directory information 10 to the computer 200 (S113), and the cellular phone 100 returns to the idle state.

The computer 200 refers to the submission directory information 10 received from the cellular phone 100 and displays the names of files and other data included in the submission directory information 10 on the display device as needed (S202).

Then, the synchronization processing performed by the cellular phone 100 is ended.

Connection Processing

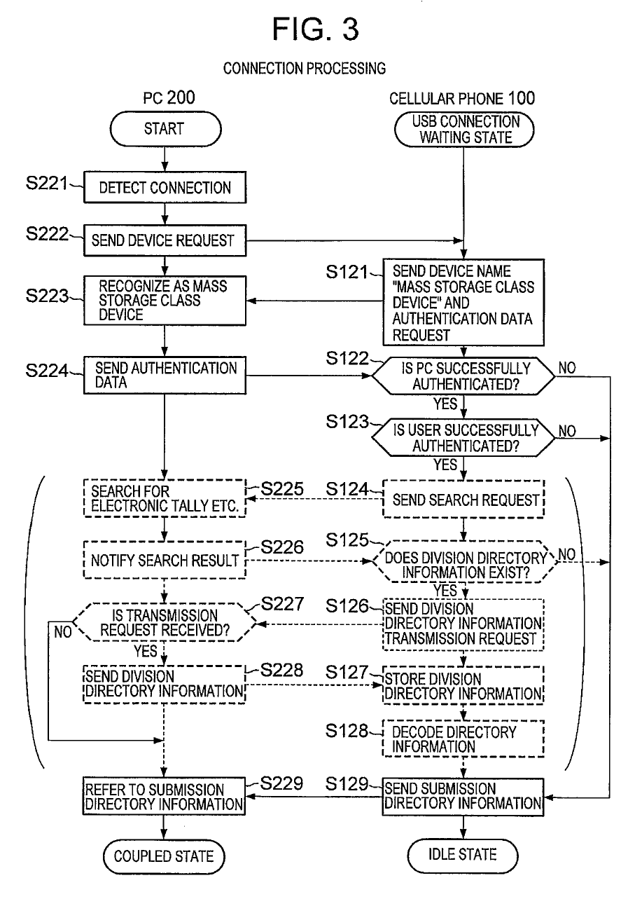

Next, connection processing performed by the cellular phone 100 and the computer 200 is described with reference to the flowchart illustrated in FIG. 3.

When the user of the cellular phone 100 establishes a USB connection between the cellular phone 100 and the computer 200, the computer 200 detects the USB connection (S221) and sends a device request to the connection destination (S222). When the emulation processing section 124 of the cellular phone 100 receives the device request via the communication control section 121, the emulation processing section 124 sends a device name “mass storage class device” and an authentication data request to the computer 200 (S121).

Note that recent cellular phones have a modem function, and the cellular phones are coupled to computers through USB connections and used as modems of the computers in some cases. When the cellular phone 100 has a modem function as described above, it is preferred that the user be asked to select one of a modem mode and a mass storage class device mode after the cellular phone 100 is coupled to the computer 200 through a USB connection, and, when the mass storage class device mode is selected, Step S121 be performed.

When the device name “mass storage class device” and the authentication data request are received from the cellular phone 100, the computer 200 recognizes the connection destination as a mass storage class device (S223) and sends authentication data of the computer 200 to the cellular phone 100 (S224).

When the authentication data is received, the authentication processing section 122 of the cellular phone 100 first performs device authentication to judge whether or not the computer 200, serving as the connection destination, is a computer specified in advance (S122). Then, the authentication processing section 122 performs user authentication to judge whether or not the user of the computer 200, serving as the connection destination, is a user specified in advance (S123). The authentication processing section 122 uses the authentication information stored in the SIM card 107, for the device authentication and the user authentication. When the authentication processing section 122 judges that the computer 200, serving as the connection destination, is the computer specified in advance, and judges that the user of the computer 200, serving as the connection destination, is the user specified in advance, the emulation processing section 124 sends submission directory information stored in any one of the volatile RAM 130 and the non-volatile RAM 140 to the computer 200 (S129). When the authentication processing section 122 judges in Step S122 that the computer 200, serving as the connection destination, is not the computer specified in advance, or judges in Step S123 that the user of the computer 200, serving as the connection destination, is not the user specified in advance, the emulation processing section 124 sends submission directory information having no information related to files to the computer 200 (S129).

When the submission directory information is received from the cellular phone 100, the computer 200 refers to the submission directory information and displays the names of files and other data included in the submission directory information on the display device as needed (S229).

Then, the connection processing is ended.

Note that authentication processing for the cellular phone 100, performed by the computer 200, is not described above, but device authentication and user authentication may also be performed by the computer 200. In that case, when any one of the device and the user cannot be successfully authenticated, a result of the authentication processing may be displayed on the display device of the computer 200.

File Reading Processing

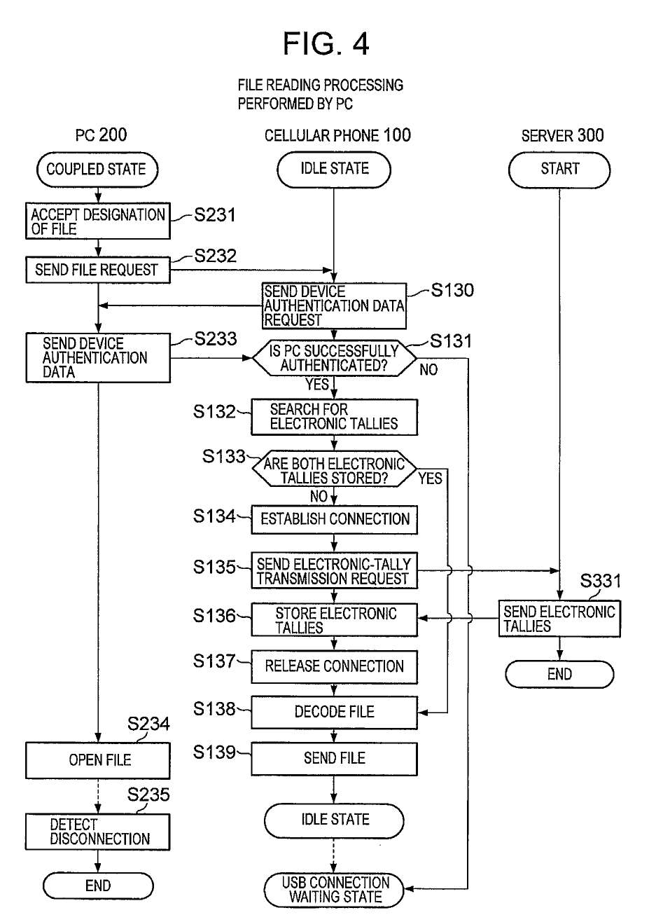

Next, file reading processing performed by the computer 200 is described with reference to the flowchart illustrated in FIG. 4.

When the display device of the computer 200 displays the names of one or more files, when the user specifies any one of the displayed names of one or more files, for example, the file “#3”, and when the computer 200 accepts the designation (S231), the computer 200 requests the cellular phone 100 to send the file “#3” (S232). When the request for the file “#3” is received, the authentication processing section 122 of the cellular phone 100 requests the computer 200 to send device authentication data (S130). When the request for the device authentication data is received, the computer 200 sends the device authentication data to the cellular phone 100 (S233). When the device authentication data is received, the authentication processing section 122 of the cellular phone 100 performs device authentication anew to judge whether or not the computer 200, serving as the connection destination, is the computer specified in advance (S131). When the authentication processing section 122 judges that the computer 200 is not the computer specified in advance, the cellular phone 100 enters the state of waiting for a USB connection. Note that this state of waiting for a USB connection is actually a pseudo state of waiting for a USB connection because the cellular phone 100 has been coupled to the computer 200. In order to transfer a file from the cellular phone 100 to the computer 200, the connection processing, described with reference to FIG. 3, needs to be performed. Further, the device authentication is performed for the purpose of preventing an unauthorized computer from impersonating the computer 200, but the device authentication may be omitted when the computer 200 and the cellular phone 100 have been continually coupled to each other after the above-mentioned connection processing, for example.

When the authentication processing section 122 judges that the computer 200, serving as the connection destination, is the computer specified in advance, the emulation processing section 124 refers to the pieces of division directory information 10b and 10n (FIGS. 6 and 7) to search for the electronic tallies “#3b” 33b and “#3n” 33n which constitute the file “#3” requested by the computer 200 (S132) to judge whether or not the electronic tallies “#3b” 33b and “#3n” 33n are stored in the cellular phone 100 (S133). When the electronic tallies “#3b” 33b and “#3n” 33n are stored in the cellular phone 100, the emulation processing section 124 uses the electronic tallies “#3b”33b and “#3n” 33n to decode the file “#3” (S138) and sends the file “#3” to the computer 200 (S139). On the other hand, when it is judged in Step S133 that at least one of the electronic tallies “#3b” 33b and “#3n” 33n, which constitute the file “#3”, is not stored in the cellular phone 100, the data reception and transmission instructing section 123 causes the communication control section 121 to operate the radio communication module to establish a connection to the server 300 (S134), and sends an electronic-tally transmission request to the server 300 (S135).

The computer 200 requests a file that is included in the directory information submitted by the cellular phone 100, and hence the file should basically be stored in the cellular phone 100. However, in this embodiment, one of two electronic tallies constituting a file is stored in the volatile RAM 130, and hence this electronic tally is deleted when the cellular phone 100 is turned off. Therefore, whether or not desired electronic tallies are stored in the cellular phone 100 is judged, and, when at least one of the electronic tallies is not stored, an electronic-tally transmission request is sent to the server 300.

When the electronic-tally transmission request is received from the cellular phone 100, the server 300 sends the pieces of division directory information 10b and 10n generated in Step S302 (FIG. 2) and the electronic tallies of all files indicated by the pieces of division directory information 10b and 10n, to the cellular phone 100 (S331). When the communication control section 121 of the cellular phone 100 receives the pieces of division directory information 10b and 10n and the electronic tallies, the data reception and transmission instructing section 123 stores the pieces of division directory information 10b and 10n and the electronic tallies in the volatile RAM 130 and the non-volatile RAM 140 (S136) and causes the communication control section 121 to release the connection to the server 300 (S137). Then, the emulation processing section 124 performs the above-mentioned file decoding (S138) and file transmission (S139).

When the requested file is received from the cellular phone 100, the computer 200 stores the file in the memory or the like and opens the file (S234). After file viewing processing, update processing, etc., when the computer 200 detects the disconnection of the cellular phone 100, the computer 200 ends its processing.

Then, the file reading processing is ended.

File Saving Processing

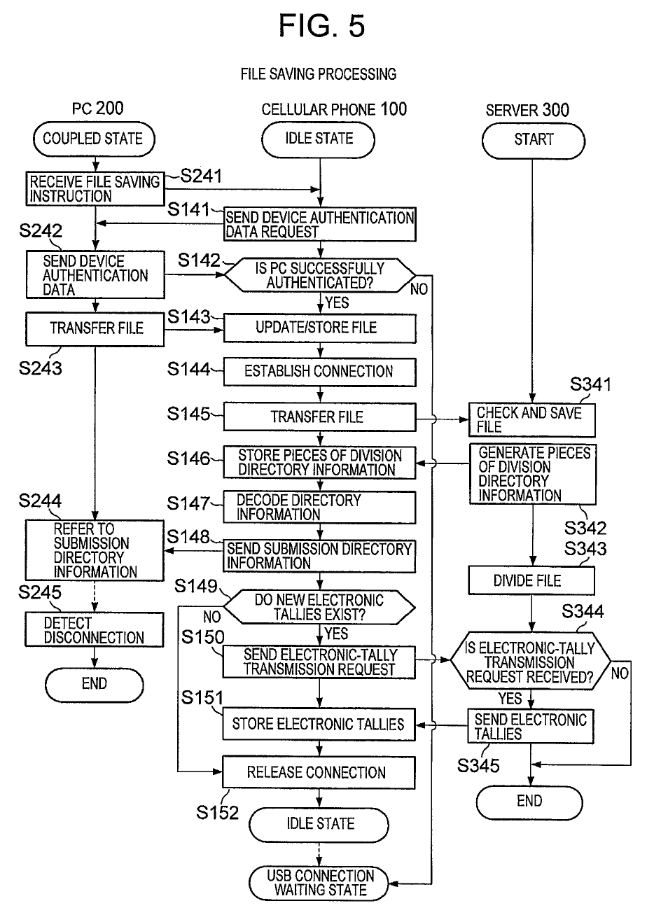

Next, saving processing of a file generated by the computer 200 is described with reference to the flowchart illustrated in FIG. 5.

When the computer 200 receives an instruction to save a particular file to the cellular phone 100, which is recognized as a mass storage class device, the computer 200 requests the cellular phone 100 to save the file (S241). When the request is received, the authentication processing section 122 of the cellular phone 100 requests the computer 200 to send device authentication data (S141). When the request for the device authentication data is received, the computer 200 sends the device authentication data to the cellular phone 100 (S242). When the device authentication data is received, the authentication processing section 122 of the cellular phone 100 performs device authentication anew to judge whether or not the computer 200, serving as the connection destination, is the computer specified in advance (S142). When the authentication processing section 122 judges that the computer 200 is not the computer specified in advance, the cellular phone 100 enters the pseudo state of waiting for a USB connection, as in the file reading processing described above. Note that the device authentication is performed for the purpose of preventing an unauthorized computer from impersonating the computer 200, but the device authentication may be omitted when the computer 200 and the cellular phone 100 have been continually coupled to each other, as described above.

When the authentication processing section 122 judges that the computer 200, serving as the connection destination, is the computer specified in advance, this judgment is returned to the computer 200. Then, the computer 200 transfers the file instructed to be saved in Step S241 to the cellular phone 100 (S243). When the file is received, the emulation processing section 124 updates the corresponding existing file or stores the received file as a new file 35 as illustrated in FIG. 6, and also adds information on the received file to the log information (S143). Note that the new file 35 is stored in the volatile RAM 130.

Then, the data reception and transmission instructing section 123 of the cellular phone 100 causes the communication control section 121 to operate the radio communication module, to establish a connection to the server 300 (S144), and to send the updated file or the new file 35 to the server 300 (S145).

Upon reception of the updated file or the new file 35, the server 300 checks viruses, an execution script such as a macro file, the copyright, etc. for the received file, and saves the received file when no problem is found (S341). The server 300 updates the directory information based on the saved file, generates pieces of division directory information, and sends the pieces of division directory information to the cellular phone 100 (S342).

When the pieces of division directory information are received, the data reception and transmission instructing section 123 stores the pieces of division directory information in the volatile RAM 130 and in the non-volatile RAM 140 (S146). The emulation processing section 124 of the cellular phone 100 decodes the pieces of division directory information stored in the volatile RAM 130 and in the non-volatile RAM 140 to generate submission directory information (S147), and sends the submission directory information to the computer 200 (S148).

After the computer 200 sends the file to the cellular phone 100, which is recognized as a mass storage class device (S243), the computer 200 tries to read the directory information to check whether the file has been successfully saved. Therefore, the emulation processing section 124 of the cellular phone 100 keeps sending a busy signal to the computer 200 until the submission directory information is generated (S147). The OS of the computer 200 receives the busy signal, judges that saving the file is delayed, and notifies the completion of saving the file to the application that has instructed to save the file. Note that instead of continuously sending a busy signal to the computer 200 until the submission directory information is generated (S147), the emulation processing section 124 of the cellular phone 100 may update the submission directory information after updating the existing file or storing the received file as the new file 35, and adding the information on the received file to the log information (S143), and send the updated submission directory information to the computer 200.

Upon reception of the submission directory information from the cellular phone 100, the computer 200 refers to the submission directory information and displays the submission directory information as needed (S244). Then, immediately or after the execution of certain processing, when the computer 200 detects the disconnection of the cellular phone 100 (S245), the computer 200 ends its processing.

After the server 300 generates the pieces of division directory information and sends the pieces of division directory information to the cellular phone 100 (S342) as described above, the server 300 divides the new file into electronic tallies (S343). Then, the server 300 waits for an electronic-tally transmission request to be sent from the cellular phone 100. When the electronic-tally transmission request is received (S344), the server 300 sends the electronic tallies constituting the new file to the cellular phone 100 (S345) and ends its processing. When the electronic-tally transmission request cannot be received from the cellular phone 100 even if a predetermined time elapses, the server 300 ends its processing immediately.

After the emulation processing section 124 of the cellular phone 100 sends the submission directory information to the computer 200 (S148) as described above, the data reception and transmission instructing section 123 of the cellular phone 100 judges whether new electronic tallies exist, depending on whether electronic-tally information (FIG. 7) is included in the pieces of division directory information 10b and 10n sent from the server 300 (S149). When the electronic-tally information is included, the data reception and transmission instructing section 123 judges that new electronic tallies exist, and sends an electronic-tally transmission request to the server 300 (S150). In response to the electronic-tally transmission request, the server 300 sends the new electronic tallies to the cellular phone 100 in Steps S344 and S345 as described above. When the new electronic tallies are received, the data reception and transmission instructing section 123 stores the new electronic tallies at the locations indicated by the file allocation included in the electronic-tally information (FIG. 7) of the pieces of division directory information 10b and 10n (S151). When the new electronic tallies are stored in Step S151 or when it is judged in Step S149 that new electronic tallies do not exist, the data reception and transmission instructing section 123 causes the communication control section 121 to release the connection to the server 300 (S152). The cellular phone 100 returns to the idle state.

Then, the file saving processing is ended.

As described above, in this embodiment, the cellular phone 100 periodically accesses the server 300 and obtains the files and the directory information from the server 300, and the computer 200 treats the cellular phone 100 as a mass storage class device. Therefore, when the user desires to obtain a file stored in the server 300, the user does not need to perform various operations such as an operation to call the server 300, and the overhead to obtain the file can be reduced.

Further, in this embodiment, a connection is established between the cellular phone 100 and the server 300 when the cellular phone 100 obtains a file and the like from the server 300. Specifically, in FIG. 2, the cellular phone 100 releases the connection immediately after receiving the electronic tallies from the server 300 (S107). Therefore, the cost of communications between the cellular phone 100 and the server 300 can be suppressed.

Further, in this embodiment, the server 300 sends data to the cellular phone 100 in the form of electronic tallies and pieces of division directory information. Basically, each of the electronic tallies or each of the pieces of division directory information has no meaning, and thus the communication security level can be maintained. Further, in this embodiment, one of electronic tallies forming a pair and one of pieces of division directory information forming a pair are stored in the volatile RAM 130. Therefore, even if the cellular phone 100 is lost, the electronic tally and the division directory information stored in the volatile RAM 130 are deleted when the battery of the cellular phone 100 runs out to turn it off, thereby also maintaining the security level of data.

In this embodiment, electronic tallies and pieces of division directory information are stored in the volatile RAM 130 and in the non-volatile RAM 140 of the cellular phone 100. However, electronic tallies and pieces of division directory information may also be stored in the computer 200 or the memory card 109 which is coupled to the cellular phone 100, in addition to the volatile RAM 130 and the non-volatile RAM 140 of the cellular phone 100. Hereinafter, Modification 1 and Modification 2 are described in which electronic tallies etc. are also stored in the memory card 109 and the computer 200, respectively.

Modification 1

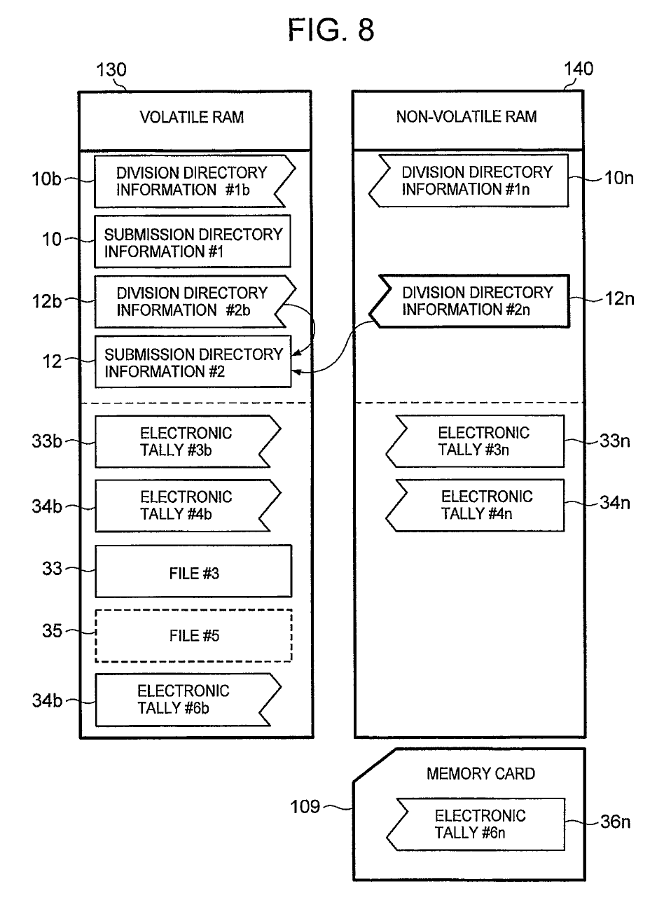

For example, when the data illustrated in FIG. 6 is stored in the volatile RAM 130 and in the non-volatile RAM 140 and when the cellular phone 100 is in the state of waiting for a USB connection, it is assumed that the memory card 109 storing an electronic tally “#6n” 36n as illustrated in FIG. 8 is inserted into the memory card slot 108 (FIG. 1).

In this case, in the flowchart of the synchronization processing illustrated in FIG. 2, the cellular phone 100 incorporates information indicating that the electronic tally “#6n” 36n is stored in the memory card 109, in the log information, and sends the log information to the server 300 (S103). In response, the server 300 generates division directory information “#2n” 12n that includes the directory information of the electronic tally “#6n” 36n and division directory information “#2b” 12b that includes the directory information of an electronic tally “#6b” 36b with which the electronic tally “#6n” 36n forms a pair, and sends the pieces of division directory information 12b and 12n to the cellular phone 100 (S301, S302). As a result, as illustrated in FIG. 8, the division directory information “#2b” 12b is stored in the volatile RAM 130 of the cellular phone 100 and the division directory information “#2n” 12n is stored in the non-volatile RAM 140 of the cellular phone 100 (S104). When the pieces of division directory information 12b and 12n are received, the cellular phone 100 judges whether new electronic tallies exist, depending on whether electronic-tally information is included in the pieces of division directory information 12b and 12n (S105). In this case, the division directory information 12b includes the electronic-tally information of the electronic tally “#6b”. Therefore, the cellular phone 100 judges that a new electronic tally exists, sends an electronic-tally transmission request to the server 300 (S106), receives the electronic tally “#6b”, and stores the electronic tally “#6b” in the volatile RAM 130 as illustrated in FIG. 8 (S107).

The pieces of division directory information 12b and 12n received from the server 300 are then used to decode submission directory information “#2” 12 (FIG. 8), and the submission directory information “#2” 12 is sent to the computer 200.

As described above, in Modification 1, the electronic tallies “#6b” and “#6n”, forming a pair, are separately held, and hence the level of security can be further enhanced.

Note that, when the memory card 109 is removed, the division directory information “#2b” 12b, the submission directory information “#2” 12, and the electronic tally “#6b” 36b, which are stored in the volatile RAM 130 of the cellular phone 100, may be deleted to further enhance the level of security.

To store the electronic tally “#6n” 36n in the memory card 109, the user may directly obtain the electronic tally “#6n” 36n from the server 300 and stores the electronic tally “#6n” 36n in the memory card 109, for example. Alternatively, another method may also be used in which, in the flowchart of the synchronization processing illustrated in FIG. 2, at the time of sending the log information (S103), the cellular phone 100 sends information indicating that the memory card 109 can be used as an electronic tally storage area to the server 300 together with the log information, and the server 300 receives them and generates division directory information with the memory card 109 being specified as an electronic tally storage area in the electronic-tally information of the division directory information.

Modification 2

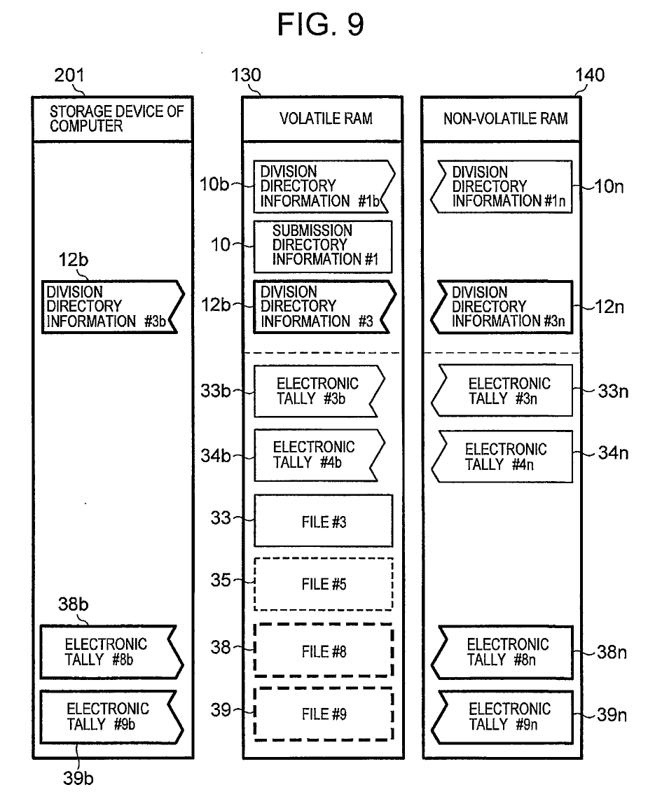

For example, as illustrated in FIG. 9, it is assumed that the storage device 201 of the computer 200 stores division directory information “#3b” 13b, an electronic tally “#8b” 38b, and an electronic tally “#9b” 39b, and the non-volatile RAM 140 of the cellular phone 100 stores division directory information “#3n” 13n, an electronic tally “#8n” 38n, and an electronic tally “#9n” 39n.

In this case, in the flowchart of the connection processing illustrated in FIG. 3, after the user of the coupled computer 200 is successfully authenticated through the user authentication (S123), the cellular phone 100 requests the computer 200 to search the storage device 201 of the computer 200 for any electronic tally or division directory information stored (S124). In response to the search request, the computer 200 searches the storage device 201 for any electronic tally etc. (S225) and notifies the search result to the cellular phone 100 (S226). Upon reception of the search result, the cellular phone 100 judges whether division directory information is stored in the storage device 201 (S125) and, when division directory information is stored, requests the computer 200 to send the division directory information (S126). When the transmission request is received (S227), the computer 200 sends the division directory information “#3b” 13b, stored in the storage device 201, to the cellular phone 100 (S228). The cellular phone 100 receives the division directory information “#3b” 13b from the computer 200 and stores the division directory information “#3b” 13b in the volatile RAM 130 (S127). The cellular phone 100 uses the division directory information “#3b” 13b and the division directory information “#3n” 13n, which is held in the cellular phone 100, to decode submission directory information “#3” 13 (S128), and sends the submission directory information “#3” 13 to the computer 200 (S129).

After the submission directory information “#3” is received, when the computer 200 requests the cellular phone 100 to send a file “#8” 38 included in the submission directory information “#3”, the cellular phone 100 searches for the electronic tallies of the file “#8” 38 (S132) in the flowchart of the file reading processing illustrated in FIG. 4. When it is found that, of the electronic tallies forming a pair, the electronic tally “#8n” 38n (FIG. 9) is stored in the non-volatile RAM 140 and the electronic tally “#8b” 38b is stored in the storage device 201 of the computer 200, the cellular phone 100 reads the electronic tally “#8b” 38b from the computer 200, decodes the file “#8” 38 from the two electronic tallies “#8b” 38b and “#8n” 38n (S138), and sends the file “#8” 38 to the computer 200 (S139).

If the file “#8” 38 is an automatic execution script file for activating a file “#9” 39, and the file “#9” 39 is an application program, when the computer 200 executes the file “#8” 38, the computer 200 tries to activate the file “#9” 39 and requests the cellular phone 100, which is recognized as a mass storage class device, to send the file “#9” 39 (S232). Then, as described above, the cellular phone 100 obtains the electronic tally “#9b” 39b of the file “#9” 39 from the computer 200, also obtains the electronic tally “#9n” 39n of the file “#9” 39 from the non-volatile RAM 140, decodes the file “#9” 39 from the electronic tallies “#9b” 39b and “#9n” 39n (S138), and sends the file “#9” 39 to the computer 200 (S139).

As described above, also in Modification 2, the electronic tallies “#8b” and “#8n”, forming a pair, etc. are separately held, and hence the level of security can be further enhanced. The storage device 201 of the computer 200 basically has a capacity larger than the memories of the cellular phone 100, and thus it is effective to use the storage device 201 of the computer 200 when a file having a large size is handled.

Note that, to store the electronic tally “#8b” 38b, the division directory information “#3b” 13b, etc. in the storage device 201 of the computer 200, there may be used a method in which, in the flowchart of the synchronization processing illustrated in FIG. 2, at the time of sending the log information (S103), the cellular phone 100 sends information indicating that the storage device 201 of the computer 200 can be used as a storage area of an electronic tally etc. to the server 300 together with the log information, as in Modification 1. The server 300 receives them and generates division directory information with the storage device 201 of the computer 200 being specified as the file allocation of the division directory information itself and as the storage area of the electronic tally indicated in the division directory information. The storage device 201 of the computer 200 can be specified as the storage area of an electronic tally and other data when the electronic tally has a size larger than a predetermined value or when the log information sent from the cellular phone 100 indicates that it may be impossible to store the electronic tally in any of the memories of the cellular phone 100, for example.

All pieces of division directory information and all electronic tallies that are sent from the server 300 are temporarily stored in the memories of the cellular phone 100. Then, in the flowchart of the synchronization processing illustrated in FIG. 2, when the cellular phone 100 judges whether new directory information exists (S110), if new directory information exists and if it is found from the new directory information that an electronic tally or the like that should be saved to the computer 200 exists, the cellular phone 100 sends the electronic tally or the like to the computer 200 (S111). Upon reception of the electronic tally or the like, the computer 200 stores the electronic tally or the like in the storage device 201.

Note that, in each of the embodiment and Modifications 1 and 2, each file and directory information is handled after being divided solely for the purpose of enhancing the security level of data. If the security level can be maintained by another method or if the security level of data is not very emphasized, it is unnecessary to divide the file and the directory information.

Further, the cellular phone has been described as an example of the communication device, but the application of the present invention is not limited to the cellular phone. For example, the present invention can be applied to any communication device, such as a wireless LAN card, as long as it can communicate with an external unit and can be coupled to a computer.

The specification and drawings are, accordingly, to be regarded in an illustrative rather than a restrictive sense. It will, however, be evident that various modifications and changes may be made thereto without departing from the spirit and scope of the invention as set forth in the claims.

What is claimed is:

1. A communication device, comprising:
communication means which performs, when the communication means is coupled to a computer, data communications between the computer and an external unit;
communication control means which causes the communication means to establish a connection to a file server which is specified in advance as a communication destination, every time a predetermined condition is satisfied;
data reception and transmission instructing means which instructs, when the connection to the file server is established, the communication control means to cause the communication means to obtain at least one file and directory information related to the at least one file, which are stored in the file server, and stores the at least one file and the directory information in a storage area; and
pseudo storage device means which notifies, when the communication means is coupled to the computer, the computer that the communication means is a mass storage class device to cause the computer to recognize the communication device as the mass storage class device, submits the directory information stored in the storage area to the computer, refers, when designation of a file contained in the directory information is accepted from the computer, to the directory information to read the file from the storage area, in which the file is stored, and sends the file to the computer.

2. A communication device according to claim 1, wherein:
the data reception and transmission instructing means causes the communication means to obtain a plurality of electronic tallies into which the file is divided, and to obtain, as the directory information, information indicating locations, in the storage area, of the plurality of electronic tallies, and stores the plurality of electronic tallies which constitute the file and the directory information in the storage area; and
the pseudo storage device means comprises file decoding means which reads, when the designation of the file is accepted from the computer, a plurality of electronic tallies which constitute the file from the storage area, and decodes the file from the plurality of electronic tallies.

3. A communication device according to claim 1, wherein:
the data reception and transmission instructing means causes the communication means to obtain a plurality of electronic tallies into which the directory information is divided, and stores the plurality of pieces of electronic tallies in the storage area; and
the pseudo storage device means comprises directory information decoding means which reads, when the directory information is submitted to the computer, the plurality of electronic tallies which constitute the directory information from the storage area, and decodes the directory information from the plurality of electronic tallies

4. A communication device according to claim 1, further comprising a memory which serves as at least part of the storage area,
wherein the data reception and transmission instructing means stores the directory information in the memory, and stores at least part of the at least one file in the memory.

5. A communication device according to claim 2, further comprising a volatile memory and a non-volatile memory which serve as at least part of the storage area,
wherein the data reception and transmission instructing means stores the directory information in at least one of the volatile memory and the non-volatile memory, and stores part of the plurality of electronic tallies which constitute the file in the volatile memory.

6. A communication device according to claim 5, wherein the data reception and transmission instructing means stores the part of the plurality of electronic tallies which constitute the file in the volatile memory, and stores remaining part of the plurality of electronic tallies in the non-volatile memory.

7. A communication device according to claim 5, wherein the pseudo storage device means searches, when the designation of the file is accepted from the computer, the storage area for the plurality of electronic tallies which constitute the file, and requests, when at least one of the plurality of electronic tallies which constitute the file is not found, the data reception and transmission instructing means to cause the communication means to establish the connection to the file server, and to obtain the at least one of the plurality of electronic tallies.

8. A communication device according to claim 3, further comprising a volatile memory and a non-volatile memory which serve as at least part of the storage area,
wherein the data reception and transmission instructing means stores part of the plurality of electronic tallies which constitute the directory information in the volatile memory, and stores remaining part of the plurality of electronic tallies in the non-volatile memory.

9. A communication device according to claim 1, wherein:
the pseudo storage device means comprises temporary saving means which receives a file from the computer, and stores the file in the storage area; and
the data reception and transmission instructing means causes, when the temporary saving means stores the file received from the computer in the storage area, the communication means to establish the connection to the file server, and to send the file to the file server.

10. A communication device, comprising:
communication means which performs, when the communication means is coupled to a computer, data communications between the computer and an external unit;
a volatile memory;
a non-volatile memory;
communication control means which causes the communication means to establish a connection to a file server which is specified in advance as a communication destination, every time a predetermined condition is satisfied;
external data acquisition means which instructs, when the connection to the file server is established, the communication control means to cause the communication means to obtain a plurality of electronic tallies into which at least one file stored in the file server is divided, stores part of the plurality of electronic tallies which constitute the file in the volatile memory, and stores remaining part of the plurality of electronic tallies in the non-volatile memory; and
pseudo storage device means which searches, when the communication means is coupled to the computer, and when designation of a file is accepted from the computer, the volatile memory and the non-volatile memory for a plurality of electronic tallies which constitute the file, decodes, when all of the plurality of electronic tallies which constitute the file are found, the file from the plurality of electronic tallies which constitute the file, and sends the file to the computer.

11. A communication device according to claim 1, being a cellular phone which comprises:
sound output means which outputs sound; and
sound input means to which the sound is input, wherein:
the communication means receives an external sound signal, and the communication control means causes the sound output means to output sound indicated by the external sound signal; and
the communication control means converts the sound input to the sound input means into a sound signal, and sends the sound signal wirelessly through the communication means.
